(19) United States
(12) Patent Application Publication
(10) Pub. No.: US 2026/0252136 A1
(43) Pub. Date: Aug. 27, 2026

(54) LOW AREA LOW MISMATCH BETA COMPENSATION BIAS CURRENT GENERATION CIRCUIT FOR BJT BASED VOLTAGE REFERENCE

(71) Applicant: STMicroelectronics International N.V., Geneva (CH)

(72) Inventor: Atul DWIVEDI, Varanasi (IN)

(73) Assignee: STMicroelectronics International N.V., Geneva (CH)

(21) Appl. No.: 19/544,635

(22) Filed: Feb. 19, 2026

Related U.S. Application Data
(60) Provisional application No. 63/764,120, filed on Feb. 27, 2025.

(51) Int. Cl. G05F 3/26

(52) U.S. Cl. CPC G05F 3/262

(57) ABSTRACT

An integrated circuit includes a reference voltage generator configured to generate a bandgap reference voltage. The integrated circuit includes a bipolar transistor configured to provide a base-emitter voltage as a voltage complimentary to absolute temperature (VCTAT) to the reference voltage generator. The integrated circuit includes a bias current generation circuit configured to generate and drive a bias current through the bipolar transistor. The bias current generation circuit utilizes pairs of resistors in two current paths to generate the bias current in manner that compensates for the β parameter of a bipolar transistor while being substantially immune to mismatches.

### BACKGROUND

### Technical Field

This present disclosure is related to integrated circuit, and more particularly, to generating a reference voltage for an integrated circuit.

### Description of the Related Art

Integrated circuits are utilized in a large variety of applications. For example, integrated circuits are utilized in mobile phones, laptop computers, tablets, desktop computers, and a large variety of electronic devices, and systems. In many instances, it is beneficial to generate a reference voltage that is substantially independent of temperature. However, there are various difficulties associated with generating a reference voltage within an integrated circuit.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which, in and of itself, may also be inventive.

### BRIEF SUMMARY

Embodiments of the present disclosure provide a bias current generation circuit that assists in generating a reference voltage that does not vary with temperature. The bias current generation circuit utilizes the inherently low mismatch in resistors to generate a bias current that is stable across mismatches. The bias current is driven through a bipolar transistor. The bias current is mismatch insensitive and compensates for β of the bipolar transistor. The reference voltage is generated based, in part, on a base-emitter voltage of the bipolar transistor.

In one embodiment, the bias current generation circuit generates a first current to assist in generating the bias current. A first portion of the first current is passed through a first current path and a second portion of the first current is passed through a second current path. A resistance architecture of the bias current generation circuit helps to ensure that the first portion of the first current has a selected ratio to the second portion. This selected ratio, in conjunction with other architecture of the bias current generation circuit, helps to ensure that the base-emitter voltage is compensated for β and is mismatch resistant.

In one embodiment, the first current is driven from a first transistor into the first and second current paths. The first and second current paths each include a respective bipolar transistor. An operational amplifier has first and second inputs coupled to the first and second current paths, respectively, and an output coupled to the gate of the first transistor. A second transistor is coupled to the first transistor in a current-mirror configuration and supplies the bias current. The output of the operational amplifier is a bias voltage that biases the gate terminals of the first and second transistors.

In one embodiment, a method includes driving a first current through a first transistor. The method includes driving a first portion of the first current through a first current path including a first bipolar transistor and a first resistor coupled between the first bipolar transistor and the first transistor. The method includes driving a second portion of the first current through a second current path having a second bipolar transistor and a second resistor coupled between the second bipolar transistor and the first transistor. The method includes generating a bias voltage with an operation amplifier having a first input coupled to a first intermediate node of the first current path and a second input coupled to a second intermediate node of the second current path. The method includes generating a base-emitter voltage of a third bipolar transistor by driving a bias current through the third bipolar transistor based on the bias voltage. The method includes generating a bandgap reference voltage based, in part, on the base-emitter voltage.

The bias current generation circuit includes a first transistor and a first current path coupled between a drain terminal of the first transistor and ground and including a first bipolar transistor, a first resistor, and a first intermediate node between the first bipolar transistor and the first resistor. The bias current generation circuit includes a second current path coupled between the drain terminal of the first transistor and ground and including a second bipolar transistor and a second resistor, and a second intermediate node between the second bipolar transistor and the second resistor. The bias current generation circuit includes an operation amplifier having a first input coupled to the first intermediate node, a second input coupled to the second intermediate node, and an output coupled to a gate terminal of the first transistor. The bias current generation circuit includes a second transistor coupled to the first transistor in a current mirror configuration and configured to output a bias current. The integrated circuit includes a third bipolar transistor coupled to receive the bias current.

In one embodiment, an integrated circuit includes a bias current generation circuit. The bias current generation circuit includes a first transistor having a source terminal coupled to a supply voltage and a first current path coupled between a drain terminal of the first transistor and ground. The first current path includes a first bipolar transistor, a first resistor coupled between the drain terminal of the first transistor and a first intermediate node of the first current path, and a second resistor coupled between the first intermediate node and an emitter terminal of the first bipolar transistor. The bias current generation circuit includes a second current path coupled between a drain terminal of the first transistor and ground. The second current path includes a second bipolar transistor, a third resistor coupled between the drain terminal of the first transistor and a second intermediate node of the second current path, and a fourth resistor coupled between a base terminal of the second bipolar transistor and ground.

### BRIEF DESCRIPTION OF THE SEVERAL VIEWS OF THE DRAWINGS

FIG. 1 is a block diagram of an integrated circuit including a bias current generation circuit, in accordance with one embodiment.

FIG. 2 is a graph illustrating a reference voltage and voltages associated with generating the reference voltage, in accordance with one embodiment.

FIG. 3 is a schematic diagram of a bias current generation circuit, in accordance with one embodiment.

FIG. 4 is a schematic diagram of a bias current generation circuit, in accordance with one embodiment.

FIG. 5 is a schematic diagram of a digital-to-analog converter, in accordance with one embodiment.

FIG. 6 is a flow diagram of a method for generating a reference voltage, in accordance with one embodiment.

### DETAILED DESCRIPTION

In the ensuing description, various specific details are illustrated aimed at enabling an in-depth understanding of the embodiments. The embodiments may be provided without one or more of the specific details, or with other methods, components, materials, etc. In other cases, known structures, materials, or operations are not shown or described in detail so that various aspects of the embodiments will not be obscured.

Reference to “an embodiment” or “one embodiment” in the framework of this description is meant to indicate that a particular configuration, structure, or characteristic described in relation to the embodiment is comprised in at least one embodiment. Hence, phrases such as “in an embodiment”, “in one embodiment”, or the like that may be present in various points of this description do not necessarily refer to one and the same embodiment. Moreover, particular conformations, structures, or characteristics may be combined in any adequate way in one or more embodiments.

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures and components associated with generation of a reference voltage of an integrated circuit have not been shown or described in detail, to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.” Further, the terms “first,” “second,” and similar indicators of sequence are to be construed as interchangeable unless the context clearly dictates otherwise.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

As used herein, the terms “bipolar transistor” and “bipolar junction transistor” are used interchangeably.

FIG. 1 is a block diagram of an integrated circuit 100, in accordance with some embodiments. The integrated circuit 100 includes a VBE generation circuit 102 including a bias current generation circuit 104. The integrated circuit 100 also includes a voltage proportional to absolute temperature (VPTAT) generator 105 and a reference voltage generator 106. As will be set forth in more detail below, the components of the integrated circuit 100 generate a reference voltage that is substantially independent of temperature.

The VBE generation circuit 102 may also be termed a voltage complimentary to absolute temperature (VCTAT) generation circuit. The VBE generation circuit generates a base-emitter voltage/VCTAT that is utilized in generating the reference voltage. Further details regarding the role of VCTAT in generating the reference voltage are provided below.

In one embodiment, the VBE generation circuit 102 includes a bias current generation circuit 104 and a bipolar transistor Q1. The bipolar transistor Q1 includes an emitter terminal coupled to the bias current generation circuit 104, a base terminal coupled to ground, and a collector terminal coupled to ground.

The bias current generation circuit 104 generates a bias current IB. The bias current generation circuit 104 drives the bias current IB through the bipolar transistor Q1. An output terminal of the bias current generation circuit 104 is coupled to the emitter terminal of the bipolar transistor Q1. The voltage at the output terminal is the base-emitter voltage VBE of the transistor Q1.

In one embodiment, VBE is temperature dependent. As temperature increases, VBE decreases in a substantially linear manner. In this way, VBE is complementary of absolute temperature. As will be described in further detail below, VBE is not perfectly linear with temperature, but exhibits curvature based, in part, on the parameter β of the bipolar transistor Q1. As generation of the reference voltage is based on VBE, curvature in VBE can result in a corresponding curvature in the reference voltage. As will be set forth in more detail below, the bias current generation circuit 104 helps to compensate for β in a manner that is substantially immune to mismatch in order to improve the linearity of VBE.

In one embodiment, the bias currents generation circuit 104 includes a first MOS transistor that supplies the bias current IB. In one embodiment, the bias current generation circuit 104 includes a second MOS transistor that is coupled to the first MOS transistor in a current mirror configuration.

In one embodiment, the bias current generation circuit 104 generates a bias voltage that biases the first MOS transistor to generate the current IB in a manner that compensates for the parameter β associated with Q1.

In a bipolar transistor, the parameter β indicates an amount of current that will flow through the base terminal of the bipolar transistor based on the current flowing through the collector of the bipolar transistor. In general, the parameter β corresponds to the ratio of the collector current to the base current. The parameter β has a slight temperature dependence. This slight temperature dependence of β can interfere with the generation of a temperature independence of the reference voltage VREF.

While the bias current generation circuit 104 compensates for β, it is nevertheless possible that other mismatches associated with the components of a bias current generation circuit could result in additional nonlinearities in VBE. The bias current generation circuit 104 utilizes the principle that resistors are significantly less prone to mismatch problems than are other circuit components in order to provide β compensation without substantial vulnerability to mismatch.

Accordingly, the bias current generation circuit 104 includes a resistor architecture 107. The resistor architecture 107 participates in generation of the bias current (or the bias voltage that controls IB). The bias current generation circuit 104 benefits from the inherent mismatch immunity associated with the resistors of the resistor architecture 107 to generate the bias current IB in a manner that compensates for β and is substantially unaffected by mismatches.

The integrated circuit 100 includes the VPTAT generator 105. The VPTAT generator 105 generates an output voltage (VPTAT) that increases in a substantially linear manner with temperature. In this way, the output voltage is proportional to absolute temperature.

In one embodiment, the VPTAT generator 105 generates VPTAT based on a first VBE of a first BJT of the VPTAT generator 105 and a second VBE of a second BJT of the VPTAT generator 105. A first current is driven through the first BJT and second, larger current is driven through the second BJT. The first and second base-emitter voltages decrease at different linear rates. Accordingly, the difference in the first and second base emitter voltages increases in a substantially linearly manner with temperature. The VPTAT generator 105 multiplies this difference voltage by a selected gain factor in order to generate the output voltage VPTAT.

The integrated circuit 100 includes the reference voltage generator 106. The reference voltage generator 106 is coupled to the VBE generation circuit 102 and the VPTAT generation circuit 105. In particular, the reference voltage generator 106 includes a first input terminal coupled to the output terminal of the VBE generation circuit 102 and receives VBE/VCTAT. The reference voltage generator 106 includes a second input terminal coupled to the output terminal of the VPTAT generation circuit 105 and receives VPTAT.

The reference voltage generator 106 generates a reference voltage VREF based on VPTAT and VCTAT. The reference voltage VREF is substantially temperature independent. In one embodiment, VREF is the sum of VPTAT and VCTAT.

In one embodiment, the reference voltage VREF is a bandgap voltage corresponding to the bandgap of a semiconductor material of the integrated circuit 100. More particularly, the bandgap voltage is the bandgap of the semiconductor material from which the bipolar transistors are formed. In one example, the semiconductor material is silicon and the bandgap voltage is about 1.2 V, corresponding to the difference between the valence band and the conduction band of silicon. Other semiconductor materials and bandgap voltages can be utilized without departing from the scope of the present disclosure.

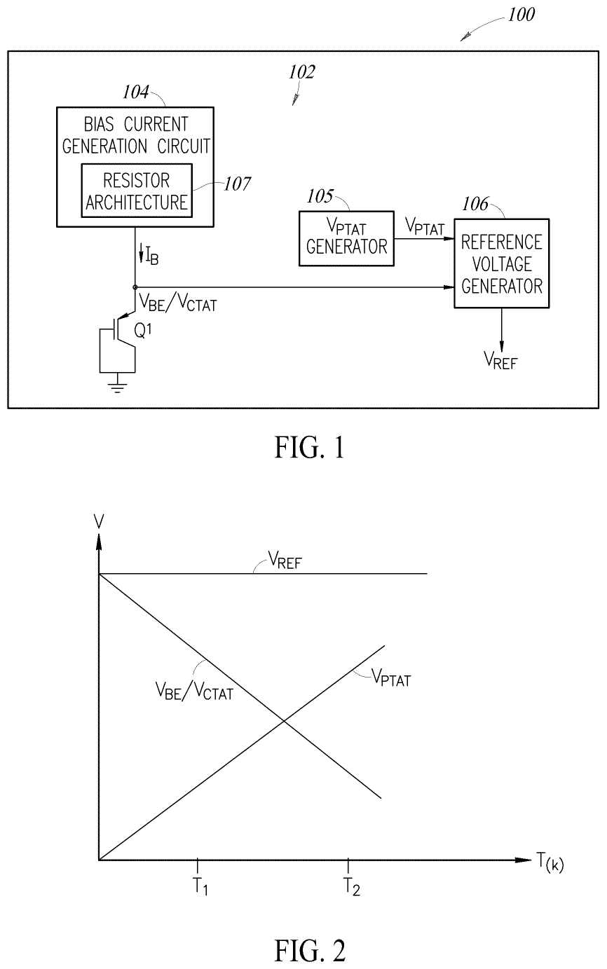

FIG. 2 is a graph illustrating various voltages generated by the integrated circuit 100 of FIG. 1 with respect to the temperature T in Kelvin, in accordance with one embodiment. FIG. 2 illustrates VBE/VCTAT generated by the VBE generation circuit 102 of FIG. 1. As described previously, VBE/VCTAT decreases with increasing temperature.

FIG. 2 also illustrates VPTAT. VPTAT increases substantially linearly with increasing temperature. As set forth previously, in one embodiment VPTAT corresponds to the difference in the base-emitter voltages of two BJTs of the VPTAT generator 105 by a proportionality constant.

FIG. 2 also illustrates the reference voltage VREF. The reference voltage generator 106 generates VREF as the sum of VCTAT and VPTAT. In one embodiment, the reference voltage VREF is a bandgap voltage corresponding to the bandgap of a semiconductor material of the integrated circuit 100. More particularly, the bandgap voltage is the bandgap of the semiconductor material from which the bipolar transistors are formed. In one example, the semiconductor material is silicon and the bandgap voltage is about 1.2 V, corresponding to the difference between the valence band and the conduction band of silicon. Other semiconductor materials and bandgap voltages can be utilized without departing from the scope of the present disclosure.

As can be seen in FIG. 2, VREF is substantially constant and independent of temperature. This is based, in part, on the fact that the bias current generation circuit 104 helps generate VBE compensated for β in a manner that is substantially immune to mismatch based on the usage of the resistor architecture 107 in generating the bias current IB.

FIG. 2 also illustrates a first temperature T1 and a second temperature T2, in accordance with one embodiment. T1 corresponds to the lower bound of an expected temperature range of the integrated circuit 100. T2 corresponds to the upper bound of an expected temperature range of the integrated circuit 100. In one embodiment, T1 is 233 K and T2 is 398 K. Other temperatures can be utilized without departing from the scope of the present disclosure.

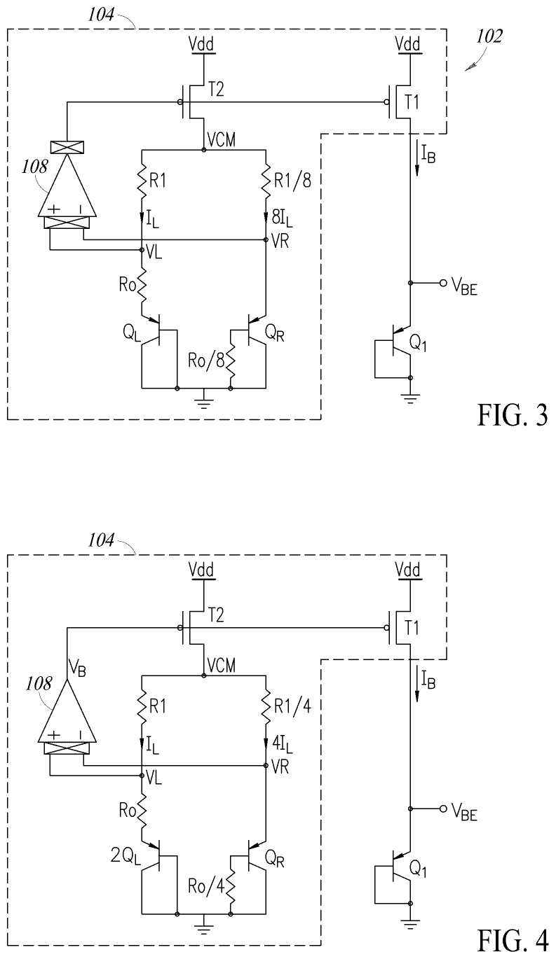

FIG. 3 is a schematic diagram of the VBE generation circuit including the bias current generation circuit 104, in accordance with some embodiments. The bias current generation circuit 104 of FIG. 3 is one example of a bias current generation circuit 104 of FIG. 1.

The bias currents generation circuit 104 includes a PMOS transistor T1 having a source terminal coupled to the supply voltage Vdd and a drain terminal coupled to the emitter terminal of the bipolar transistor Q1. The transistor T1 corresponds to a current source providing the bias current IB. The bias current generation circuit includes a transistor T2 coupled to the transistor T1 in a current mirror configuration. The transistors T1 and T2 each receive the bias voltage VB. The transistor T1 generates the bias current IB, based on a bias voltage VB.

The bias current generation circuit 104 includes a node VCM coupled to the drain terminal of the transistor T2. A left current branch and a right current branch are each coupled between VCM and ground. The left current branch receives a first portion IL of the current flowing through the transistor T2. The right current branch receives a second portion of the current flowing through the transistor T2. The second portion is related to the first portion IL by a selected proportionality constant. In the example of FIG. 3, the proportionality constant is 8. Accordingly, the second portion of the current flowing through the right current branch is 8IL, in the example of FIG. 3.

The left current branch includes a resistor R1 coupled between VCM and an intermediate node VL. The left current branch includes a bipolar transistor QL having a collector terminal and a base terminal coupled to ground. The left current branch includes a resistor Ro coupled between R1 and the emitter terminal of the transistor QL.

The right current branch includes a resistor R1/8 coupled between VCM and an intermediate node VR. In other words, the resistor has a resistance corresponding to the resistance of the resistor R1 of the left current branch divided by the proportionality constant 8. The right current branch includes a bipolar transistor QR having a collector terminal coupled to ground and an emitter terminal coupled to the node VR. A resistor Ro/8 is coupled between the base terminal of the transistor QR and ground. In other words, the resistor coupled between the base terminal of the bipolar transistor QR and ground has a resistance corresponding to the resistance of the resistor Ro of the left branch divided by the proportionality constant 8. As set forth previously, other proportionality constants can be utilized without departing from the scope of the present disclosure.

The bias current generation circuit 104 includes an operational amplifier 108, according to one embodiment. The operational amplifier 108 includes a first input coupled to VL and a second input coupled to VR. In other words, the first input receives an intermediate voltage of the left current path and the second input receives an intermediate voltage of the right current path. The operational amplifier 110 includes an output terminal that supplies the bias voltage VB. The inputs of the operational amplifier 108 are chopped. The output of the operational amplifier 108 is also chopped. The chopping of the operational amplifier 108 eliminates errors due to internal offsets of the operational amplifier 108.

In one embodiment, the operational amplifier 108 operates to ensure that the voltage at VL is equal to the voltage at VR. The current in the right-hand path (IR) is equal to 8*IL. This results in the following relationship:

$$IL * RO + VBEL = 8 IL \times \frac{1}{β + 1} \times RO / 8 + V B E R ,$$

where VBEL is the base-emitter voltage of QL and VBER is the base-emitter voltage of QR. Rewriting the above relationship yields:

$$I * RO \times ( 1 - \frac{1}{β + 1} ) = V B E R - V B E L .$$

Rewriting this relationship further yields:

$$IB = \frac{( β + 1 )}{β} Δ VBERL / Ro ,$$

where ΔVBE_{RL} corresponds to the difference between VBER and VBEL. The generation of the bias voltage in the manner described above, controls the generation of the bias current IB. VBE depends on the collector current. However, the collector current IC is not directly accessible in a parasitic PNP bipolar transistor in CMOS technology, so the BJT is biased only via the emitter. The portion of the bias current IB (the bias current is the emitter current in this case) that reaches the collector is:

$$IC = \frac{β * IB}{( β + 1 )}$$

Accordingly, to remove the dependence of β from the collector current (and, thus, from VBE), IB is generated by the bias current generation circuit 104 in the following manner:

$$IB = \frac{( β + 1 )}{β} Id ,$$

where Id is the current that is desired to flow through the collector. The β terms cancel out, and the collector current IC is independent of beta and is equal to the desired current Id. As VBE depends on IC, VBE is also independent of beta. Generation of the bias current in this manner results in VBE/VCTAT that is β compensated. Furthermore, the usage of the resistor architecture results in VBE being highly insensitive to mismatches.

In one embodiment, the bias current generation circuit 104 employes resistors having selected ratios. In one embodiment, the resistors of the bias current generation circuit 104 are polysilicon resistors. Owing to the mismatching performance of polysilicon resistors, the resulting current ratio is substantially immune to mismatch effects. Because the absolute value of R1 does not matter, the value of R1 can be quite small.

The bias current generation circuit 104 of FIG. 3 provides various benefits in accordance with some embodiments. The bias current generation circuit 104 generates currents having a selected ratio based on the resistors. Because the resistors have a much lower mismatch compared to MOS current sources, the connection arrangements of the bias current generator 104 ensure that the current distribution in the two BJT branches of bias current generation circuit is completely dependent on resistor ratio only. Thus, for all practical purposes, the mismatch effect is eliminated completely. Because the proper current ratio is achieved, the curvature errors due to β variations in VBE components of VREF is compensated to a very high degree, irrespective of local mismatches.

FIG. 4 is a schematic diagram of a bias current generation circuit 104, in accordance with one embodiment. The bias current generation circuit 104 of FIG. 4 is substantially similar to the bias current generation circuit 104 of FIG. 3, except that the transistor QL is twice as large as the transistor QR. Furthermore, the resistors of the right current path have resistances that are smaller than the corresponding resistances of the left current path by a factor that is only half the proportionality constant of FIG. 3. For example, the resistances in the right path are smaller by only a factor of 4. This can help ensure that QR does not sink too much current, thereby reducing the risk that QR will enter a high injection region. The working principle is the same as FIG. 3 in that the resulting current IB is β-compensated.

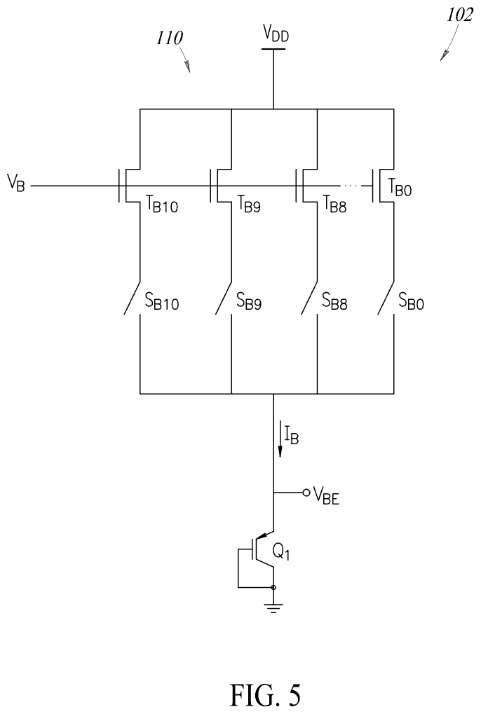

FIG. 5 is a schematic diagram of a calibration digital-to-analog converter (DAC) 110, in accordance with some embodiments. The DAC 110 is part of the bias current generation circuit 104. In one example, the DAC 110 corresponds to the MOS transistor T1 of FIGS. 3 and 4. In some embodiments, the calibration described below helps to eliminate process dependent linear errors in VBE.

In FIG. 5, the DAC 110 has eleven transistors TB0-TB10. Each of the transistors TB0-TB10 receives the bias voltage VB. Each of the transistors TB0-TB10 has a different size. Thus, for same bias voltage VB, each transistor TB0-TB10 will generate a different current based on the size of the transistor. In one example, the transistor each transistor is double the size of the transistor to its right and will generate, for a given VB, a current that is twice as large as the transistor to its right. Accordingly, the transistor TB10 is twice as large as the transistor TB9. The transistor TB9 is twice as large as the transistor TB8, and so forth until the transistor TB0, which is the smallest of all.

The DAC 110 includes a plurality of control switches SB0-SB10. In particular, switch SB0-SB10 is coupled below a respective transistor TB0-TB10. Each switch SB0-SB10 controls whether or not the corresponding transistor TB0-TB10 will contribute to the bias current IB. If a switch is open, the corresponding transistor will not contribute to the bias current IB. If a switch is closed, the corresponding transistor will contribute to the bias current IB.

The function of the calibration DAC 110 is to enable calibration of VCTAT by calibrating IB. The switches of the DAC 110 are controlled by an 11-bit calibration code <10:0>. Each bit of the calibration code determines whether or not a corresponding switch is open or closed. During calibration, the calibration code is selected so that VCTAT has a desired slope. While FIG. 5 illustrates a DAC 110 having 11 current paths, other numbers of current paths can be selected without departing from the scope of the present disclosure.

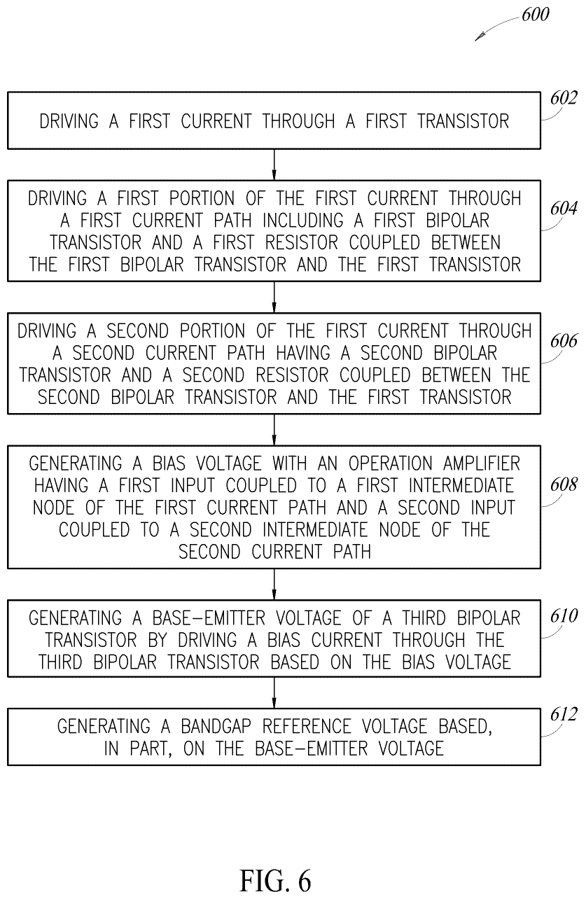

FIG. 6 is a flow diagram of a method 600 for operating an integrated circuit, in accordance with one embodiment. The method 600 can utilize components, systems, and processes described in relation to FIGS. 1-5. At 602, the method 600 includes driving a first current through a first transistor. At 604, the method 600 includes driving a first portion of the first current through a first current path including a first bipolar transistor and a first resistor coupled between the first bipolar transistor and the first transistor. At 606, the method 600 includes driving a second portion of the first current through a second current path having a second bipolar transistor and a second resistor coupled between the second bipolar transistor and the first transistor. At 608, the method 600 includes generating a bias voltage with an operation amplifier having a first input coupled to a first intermediate node of the first current path and a second input coupled to a second intermediate node of the second current path. At 610, the method 600 includes generating a base-emitter voltage of a third bipolar transistor by driving a bias current through the third bipolar transistor based on the bias voltage. At 612, the method 600 includes generating a bandgap reference voltage based, in part, on the base-emitter voltage.

In one embodiment, a method includes driving a first current through a first transistor. The method includes driving a first portion of the first current through a first current path including a first bipolar transistor and a first resistor coupled between the first bipolar transistor and the first transistor. The method includes driving a second portion of the first current through a second current path having a second bipolar transistor and a second resistor coupled between the second bipolar transistor and the first transistor. The method includes generating a bias voltage with an operation amplifier having a first input coupled to a first intermediate node of the first current path and a second input coupled to a second intermediate node of the second current path. The method includes generating a base-emitter voltage of a third bipolar transistor by driving a bias current through the third bipolar transistor based on the bias voltage. The method includes generating a bandgap reference voltage based, in part, on the base-emitter voltage.

The bias current generation circuit includes a first transistor and a first current path coupled between a drain terminal of the first transistor and ground and including a first bipolar transistor, a first resistor, and a first intermediate node between the first bipolar transistor and the first resistor. The bias current generation circuit includes a second current path coupled between the drain terminal of the first transistor and ground and including a second bipolar transistor and a second resistor, and a second intermediate node between the second bipolar transistor and the second resistor. The bias current generation circuit includes an operation amplifier having a first input coupled to the first intermediate node, a second input coupled to the second intermediate node, and an output coupled to a gate terminal of the first transistor. The bias current generation circuit includes a second transistor coupled to the first transistor in a current mirror configuration and configured to output a bias current. The integrated circuit includes a third bipolar transistor coupled to receive the bias current.

In one embodiment, an integrated circuit includes a bias current generation circuit. The bias current generation circuit includes a first transistor having a source terminal coupled to a supply voltage and a first current path coupled between a drain terminal of the first transistor and ground. The first current path includes a first bipolar transistor, a first resistor coupled between the drain terminal of the first transistor and a first intermediate node of the first current path, and a second resistor coupled between the first intermediate node and an emitter terminal of the first bipolar transistor. The bias current generation circuit includes a second current path coupled between a drain terminal of the first transistor and ground. The second current path includes a second bipolar transistor, a third resistor coupled between the drain terminal of the first transistor and a second intermediate node of the second current path, and a fourth resistor coupled between a base terminal of the second bipolar transistor and ground.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
driving a first current through a first transistor;
driving a first portion of the first current through a first current path including a first bipolar transistor and a first resistor coupled between the first bipolar transistor and the first transistor;
driving a second portion of the first current through a second current path having a second bipolar transistor and a second resistor coupled between the second bipolar transistor and the first transistor;
generating a bias voltage with an operation amplifier having a first input coupled to a first intermediate node of the first current path and a second input coupled to a second intermediate node of the second current path;
generating a base-emitter voltage of a third bipolar transistor by driving a bias current through the third bipolar transistor based on the bias voltage; and
generating a bandgap reference voltage based, in part, on the base-emitter voltage.

2. The method of claim 1, wherein the first resistor is coupled between the first transistor and the first intermediate node, wherein the second resistor is coupled between the first transistor and the second intermediate node.

3. The method of claim 2, wherein the first current path includes a third resistor coupled between the first intermediate node and an emitter terminal of the first bipolar transistor, wherein a fourth transistor is coupled between a base terminal of the fourth transistor and ground.

4. The method of claim 3, wherein first resistor has a resistance greater than a resistance of the second resistor by of a factor P, wherein the third resistor has a resistance greater than a resistance of the fourth resistor by the factor P.

5. The method of claim 2, comprising chopping the first and second inputs of the operational amplifier.

6. The method of claim 5, comprising chopping the output of the operational amplifier.

7. The method of claim 6 comprising:
generating a voltage proportional to absolute temperature; and
generating the bandgap reference voltage as a sum of the base-emitter voltage of the third transistor and the voltage proportional to absolute temperature.

8. The method of claim 6, wherein the first bipolar transistor is twice as large as the second bipolar transistor.

9. The method of claim 2, wherein the first and second resistors are polysilicon.

10. The method of claim 1, comprising sensing a temperature of the integrated circuit based on the bandgap reference voltage.

11. An integrated circuit, comprising:
a bias current generation circuit, including:
a first transistor;
a first current path coupled between a drain terminal of the first transistor and ground and including a first bipolar transistor, a first resistor, and a first intermediate node between the first bipolar transistor and the first resistor;
a second current path coupled between the drain terminal of the first transistor and ground and including a second bipolar transistor and a second resistor, and a second intermediate node between the second bipolar transistor and the second resistor;
an operation amplifier having a first input coupled to the first intermediate node, a second input coupled to the second intermediate node, and an output coupled to a gate terminal of the first transistor; and a second transistor coupled to the first transistor in a current mirror configuration and configured to output a bias current;
a third bipolar transistor coupled to receive the bias current.

12. The integrated circuit of claim 11, comprising a reference voltage generator coupled to an emitter terminal of the third bipolar transistor and configured to generate a bandgap reference voltage based, in part, on a base-emitter voltage of the third transistor.

13. The integrated circuit of claim 11, wherein:
the first resistor is coupled between the drain terminal of the first transistor and the first intermediate node; and
the second resistor is coupled between the drain terminal of the first transistor and the second intermediate node.

14. The integrated circuit of claim 13, wherein:
the first current path includes a third resistor coupled between the first intermediate node and an emitter terminal of the first bipolar transistor; and
the second current path includes a fourth transistor coupled between a base terminal of the fourth bipolar transistor and ground.

15. The integrated circuit of claim 14, wherein first resistor has a resistance greater than a resistance of the second resistor by a factor P, wherein the third resistor has a resistance greater than a resistance of the fourth resistor by the factor P.

16. The integrated circuit of claim 14, wherein the first bipolar transistor is twice as large as the first bipolar transistor.

17. The integrated circuit of claim 16, comprising a calibration digital to analog converter including the first transistor.

18. The integrated circuit of claim 17, comprising a voltage proportional to absolute temperature generator configured to supply a voltage proportional to absolute temperature to the reference voltage generator, wherein the reference voltage generator is configured to generate the reference voltage as a sum of the voltage proportional to absolute temperature and the base-emitter voltage of the third bipolar transistor.

19. An integrated circuit, comprising a bias current generation circuit, including:
a first transistor having a source terminal coupled to a supply voltage;
a first current path coupled between a drain terminal of the first transistor and ground and including:
a first bipolar transistor;
a first resistor coupled between the drain terminal of the first transistor and a first intermediate node of the first current path; and
a second resistor coupled between the first intermediate node and an emitter terminal of the first bipolar transistor; and
a second current path coupled between a drain terminal of the first transistor and ground and including:
a second bipolar transistor;
a third resistor coupled between the drain terminal of the first transistor and a second intermediate node of the second current path; and
a fourth resistor coupled between a base terminal of the second bipolar transistor and ground.

20. The integrated circuit of claim 19, wherein the bias current generation circuit includes an operation amplifier having a first input coupled to the first intermediate node, a second input coupled to the second intermediate node, and an output coupled to a gate terminal of the first transistor.

21. The integrated circuit of claim 19, wherein the bias current generator includes a second transistor coupled to the first transistor in a current mirror configuration and configured to generate a bias current, the integrated circuit comprising:
a third bipolar transistor coupled to receive the bias current; and
a reference voltage generator coupled to an emitter terminal of the third bipolar transistor and configured to generate a bandgap reference voltage based, in part, on a base-emitter voltage of the third bipolar transistor.
